(19) United States
(12) Patent Application Publication
(10) Pub. No.: US 2012/0317603 A1
(43) Pub. Date: Dec. 13, 2012

(54) Methods circuits & systems for transmitting and receiving data, including video data

(76) Inventors: Daniel Stopler, Holon (IL); Guy Dorman, Holon (IL); Zvi Reznic, Tel Aviv (IL)

(21) Appl. No.: 13/067,557

(22) Filed: Jun. 9, 2011

(51) Int. Cl. H04N 7/18

(52) U.S. Cl. 725/81

(57) ABSTRACT

Disclosed are methods, circuits, apparatus, devices and systems for transmitting and receiving data, including video data. All or some portions of a video frame (i.e. video block) may be processed and/or converted into frequency domain coefficients (e.g. DCT, DFT, etc.). Some or all of the frequency domain coefficients may be encapsulated within a transmission frame (e.g. an OFDM based transmission frame) and may be transmitted to a functionally associated receiver over a transmission channel. Not all frequency coefficients may be encapsulated and transmitted, possibly due to bandwidth limitations on the transmission channel. Selection (i.e. allocation) of one or more frequency coefficients to be transmitted may be based on a Visual Quality Metric (VQM) of the associated video block, such that encapsulation and transmission preference/priority may be given to maximize the VQM of the video block. A higher video block VQM may result in a lower transmitted distortion.

### FIELD OF THE INVENTION

Some embodiments relate generally to the field of communication and, more particularly, to methods, circuits & systems for transmitting and receiving data, including video data.

### BACKGROUND

Wireless communication has rapidly evolved over the past decades. Even today, when high performance and high bandwidth wireless communication equipment is made available, there is demand for even higher performance at a higher data rates, which may be required by more demanding applications.

Video signals may be generated by various video sources, for example, a computer, a game console, a Video Cassette Recorder (VCR), a Digital-Versatile-Disc (DVD), a Blu-ray (BR) disk player, or any other suitable video source. In many houses, for example, video signals are received through cable or satellite links at a Set-Top Box (STB) located at a fixed point.

In many cases, it may be desired to place a screen or projector at a location in a distance of at least a few meters from the video source. This trend is becoming more common as flat-screen displays, e.g., plasma or Liquid Crystal Display (LCD) televisions are hung on a wall. Connection of such a display or projector to the video source through cables is generally undesired for aesthetic reasons and/or installation convenience. Thus, wireless transmission of the video signals from the video source to the screen is preferred.

Video signals may be generated or received by various mobile computing or communications devices, for example, a laptop computer, a netbook, a tablet computer, a smart phone, a game console, an e-book reader, or any other suitable mobile computing or communications device. In many devices, for example, video signals are generated by the device to view on an integral viewing screen, store or transmit to a functionally associated device. Video signals may be received from a functionally associated device, an internal or external memory, a data server, a streaming application, a removable media storage device or any other suitable media storage.

In many cases, the integral viewing screen may be too small and/or may be of poor quality for certain applications (e.g. high definition movie viewing). It may be desired to place a screen or projector at a location in a distance of at least a few meters from the video source. This trend is becoming more common as flat-screen displays, e.g., plasma or Liquid Crystal Display (LCD) televisions are hung on a wall. Connection of such a display or projector to the video source through cables is generally undesired for aesthetic reasons and/or installation convenience. Thus, wireless transmission of the video signals from the video source to the screen is preferred.

WHDI—Wireless Home Digital Interface is a standard for wireless high-definition video connectivity between a video source and video sink (e.g. display). It provides a high-quality, uncompressed wireless link which can support delivery of equivalent video data rates of up to 3 Gbit/s (including uncompressed 1080p and stereoscopic 3-D) in a 40 MHz channel within the 5 GHz unlicensed band. Equivalent video data rates of up to 1.5 Gbit/s (including uncompressed 1080i and 720p) can be delivered on a single 20 MHz channel in the 5 GHz unlicensed band, conforming to worldwide 5 GHz spectrum regulations. Range is beyond 100 feet (30 m), through walls, and latency is less than one millisecond.

WHDI 1.0 uses a fixed allocation of taps (i.e. coefficients transmitted) per DCT block. While the size of the allocation is designed to be sufficient for reproducing the most difficult (high frequency) blocks with minimal distortion, many DCT blocks require far fewer taps. A fixed allocation of taps is not an optimal design. By allocating a different number of taps for each DCT block, i.e. more taps for difficult blocks and fewer taps for easy blocks, image quality may be improved with a reduced number of taps.

There is thus a need in the field of wireless communication for improved methods, circuits and systems for transmitting and receiving data, including video data and devices implementing said methods, circuits and systems.

### SUMMARY OF THE INVENTION

The present invention includes methods, circuits, apparatus, devices and systems for transmitting and receiving data, including video data. According to some embodiments, all or some portions of a video frame (i.e. video block) may be processed and/or converted into frequency domain coefficients (e.g. DCT, DFT, etc.). Some or all of the frequency domain coefficients may be encapsulated within a transmission frame (e.g. an OFDM based transmission frame) and may be transmitted to a functionally associated receiver over a transmission channel. According to some embodiments of the present invention, not all frequency coefficients may be encapsulated and transmitted, possibly due to bandwidth limitations on the transmission channel. Selection (i.e. allocation) of one or more frequency coefficients to be transmitted may be based on a Visual Quality Metric (VQM) of the associated video block, such that encapsulation and transmission preference/priority may be given to maximize the VQM of the video block. According to further embodiments of the present invention, a higher video block VQM may result in a lower transmitted distortion.

According to some embodiments of the present invention, a VQM of a given video block may be a function of the frequency coefficients of the given block, the allocation of frequency coefficients of the given block, the frequency coefficients not allocated, energy levels of non-allocated frequency coefficients, and/or an illumination level of the given block. According to further embodiments of the present invention, the VQM of the given video block may be a function of an illumination level and/or the frequency content of the allocated frequency coefficients of one or more blocks neighboring the given block.

According to some embodiments of the present invention, there may be a given video block from a set of video blocks with a minimum VQM. According to further embodiments of the present invention, the given video block may receive coefficients allocation preference/priority to maximize the VQM of the given video block. According to further embodiments of the present invention, an energy level (i.e. peak signal to noise ratio—PSNR) value may be calculated for each block of coefficients associated with a given video frame. For a given block of coefficients found to have a low PSNR value (i.e. a video block with a high level of distortion), more coefficients associated with the given video block may be allocated for transmission to maximize the PSNR.

According to some embodiments of the present invention, an allocation of coefficients may be ordered according to a selectable ordering scheme, wherein the ordering scheme is selected for the highest attainable VQM. According to further embodiments, a given video block may have a higher VQM when utilizing a diagonal (i.e. zigzag) ordering of coefficients. According to further embodiments, a given video block may have a higher VQM when utilizing a vertical line ordering of coefficients. A code describing the ordering of coefficients may be transmitted to a functionally associated receiver using a reliable transmission method (e.g. with forward error correction and/or acknowledgement receipts).

According to some embodiments of the present invention, VQM maximization for a given video block may be constrained by a determined available transmission bandwidth. According to further embodiments of the present invention, there may be determined a target VQM for a set of video blocks. The target VQM may be maintained by all blocks from the set of blocks within the determined available bandwidth.

According to some embodiments of the present invention, there may be determined a VQM donation threshold for a set of video blocks. A video block from the set of blocks with a VQM lower than the VQM donation threshold may be guaranteed a minimum number of coefficients allocated for transmission (i.e. a minimum allowed allocation size). According to further embodiments of the present invention, an allocation size smaller than the guaranteed minimum allocation size may be a disallowed allocation.

According to some embodiments of the present invention, when a given video block has a VQM above the determined target VQM, fewer frequency coefficients may be allocated for transmission. According to further embodiments when fewer frequency coefficients are allocated for a given block, the potential for greater coefficient allocation may be donated to an associated intra-frame video block with a VQM below the static or dynamic threshold level. The given block may donate coefficient allocation until the VQM threshold is met. According to further embodiments, a dynamic VQM threshold may vary based on available bandwidth on the transmission channel, such that the VQM threshold level may be proportional to the available bandwidth.

According to some embodiments of the present invention, a grouping of associated intra-frame video blocks may be referred to as a superblock. According to further embodiments of the present invention, a coefficient allocation of one or more of the video blocks may be raised or lowered depending on a superblock-wide coefficient budget constraint (i.e. a total coefficient allocation for each superblock). The coefficient budget constraint may be dynamic based on transmission channel limitations. According to further embodiments of the present invention, for each video block in the superblock, the number of allocated coefficients may be selected from a predetermined group of possible values (e.g. 27, 54, 81, 108, 135, 162 or 192). A code describing the number of allocated coefficients may be transmitted to a functionally associated receiver using a reliable transmission method (e.g. with forward error correction and/or acknowledgement receipts).

According to some embodiments of the present invention, a given video block may include a string of low energy coefficients. According to further embodiments of the present invention, a string of coefficients with an energy level below some static or dynamic threshold (i.e. a zero run) may be discarded (i.e. not transmitted). A data code, including a zero run length value and an index offset value may be transmitted to a functionally associated receiver using a reliable transmission method (e.g. with forward error correction and/or acknowledgement receipts). According to further embodiments of the present invention, a functionally associated receiver may consider the coefficients comprising a zero run to have a substantially zero energy value.

According to some embodiments of the present invention, when determining the highest available VQM for a given video block, one or more allocation sizes may be tested. According to further embodiments of the present invention, for each allocation size tested, one or more coefficient ordering schemes (e.g. zigzag, columns, rows, etc.) may be tested for the highest available VQM. According to yet further embodiments of the present invention, for each allocation size tested and/or for each coefficient ordering scheme tested, optimal zero runs may be tested for the highest available VQM.

According to some embodiments of the present invention, a video stream may be composed of sequential video frames, and each video frame may be composed of one or more video blocks including one or more sets of pixels. Prior to transmission of the data associated with a video block, the video block data may be transformed into a set of transform (e.g. frequency) coefficients using a spatial to frequency transform such as a two dimensional discrete cosine transform (DCT). According to some embodiments of the present invention, only a portion or subset of the coefficients of a given video block may be transmitted. Selection of the subset of transform coefficients to be transmitted may be based on a characteristic of the video block. According to further embodiments of the present invention, only a portion or subset of coefficients chosen for transmission may be calculated and transmitted.

According to further embodiments of the present invention, a first portion or subset of the coefficients may be transmitted using a first RF data link and a second portion or subset of the coefficients may be transmitted using a second RF link. One of the RF link may be more secure and/or reliable than the other RF link (e.g. with forward error correction and/or acknowledgement receipts). One set of coefficients may include more spatial information than another set of coefficients.

According to some embodiments of the present invention, when a given video block is determined to be static, frequency coefficients not previously transmitted for a corresponding block may be transmitted. An indicator indicating that this block is static may be transmitted along with the selected coefficients. An image reconstruction module (e.g. decoder and graphics circuit) on the receiver side (e.g. video sink) may receive the indicator and in response may keep a previously generated video block image and may use the received coefficients to augment or enhance the previously generated video block image. The coefficient set selected for a video block designated as static may also include coefficients previously transmitted for a corresponding block from the previous frame. These retransmitted coefficients, which were transmitted as part of the previous frame, may be used by the reconstruction module to enhance the displayed video image by averaging corresponding coefficient values.

According to some embodiments of the present invention, there may be proportionality between the subset of coefficients selected and the security and reliability of the transmission link (e.g. optional forward error correction and/or acknowledgement receipts). According to some embodiments of the present invention, the security and reliability may be based on the strength of the transmission link and/or the type of transmitter used from a plurality of available transmitters. According to some embodiments of the present invention, an RF link with low security and reliability may transmit block transform coefficient data along unreliable bit streams which may not include data link protocols including data frames and/or flow/error control. According to further embodiments of the present invention, a secure and reliable RF link may include data link protocols including the framing of coefficient data and/or flow/error control. According to some embodiments of the present invention, acknowledgments, negative acknowledgements, error detection and/or correction, and checksums may be implemented as features of a secure and reliable RF link.

According to further embodiments of the present invention, video signals may be transmitted using transmission symbols comprised of video data frame coefficients. According to further embodiments of the present invention, low spatial frequency coefficients (i.e. DC coefficients, and/or near DC coefficients) may be represented in a coarse, (i.e. digital) manner. According to further embodiments of the present invention, the low spatial frequency coefficients may be represented as one or more of a plurality of constellation points of a symbol by performing a quantization on their values and mapping them. Coarse data transmission may include additional data values and/or vectors relating to a subset of associated relatively higher frequency coefficients to be transmitted within a separate transmission frame.

According to some embodiments of the present invention, relatively higher frequency coefficients and the quantization errors of the DC and the near DC components may be mapped as fine-constellation points thus providing the fine granularity (i.e. analog-like) values that at an extreme fineness provides for a continuous representation of these values. Further details with regard to methods and systems of uncompressed, wireless transmission of video are described in U.S. patent application Ser. No. 11/551,641 which application is hereby incorporated by reference in its entirety.

According to some embodiments of the present invention, frequency coefficient based transmission symbols may be transmitted using a quadrature amplitude modulation (QAM) based transmitter, an orthogonal frequency-division multiplexing (OFDM) based transmitter, or any other transmitter adapted to transmit data using transmission symbols. According to further embodiments of the present invention, transmission symbol processing may be performed by an integral DSP or by a fast Fourier transformer (FFT) co-processor.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows an exemplary video source transceiver and video sink transceiver arrangement, according to some embodiments of the present invention;

FIG. 2 is a functional block diagram of an exemplary video source transceiver according to some embodiments of the present invention, where the video source transceiver includes a coefficient selector;

FIG. 3 is a functional block diagram of an exemplary coefficient selector and symbol generator, according to some embodiments of the present invention;

FIG. 4 shows a flowchart including the steps performed by the video source transceiver, according to some embodiments of the present invention;

FIG. 5A is a schematic diagram showing computational parallelization of superblock coefficients according to some embodiments of the present invention;

FIG. 5B is a schematic diagram showing selectable video block coefficients ordering according to some embodiments of the present invention; and

FIG. 6 is a schematic diagram showing superblock coefficients selection based on block-specific energy levels according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

It should be understood that some embodiments may be used in a variety of applications. Although embodiments of the invention are not limited in this respect, one or more of the methods, devices and/or systems disclosed herein may be used in many applications, e.g., civil applications, military applications, medical applications, commercial applications, or any other suitable application. In some demonstrative embodiments the methods, devices and/or systems disclosed herein may be used in the field of consumer electronics, for example, as part of any suitable television, video Accessories, Digital-Versatile-Disc (DVD), multimedia projectors, Audio and/or Video (A/V) receivers/transmitters, gaming consoles, video cameras, video recorders, portable media players, cell phones, mobile devices, and/or automobile A/V accessories. In some demonstrative embodiments the methods, devices and/or systems disclosed herein may be used in the field of Personal Computers (PC), for example, as part of any suitable desktop PC, notebook PC, monitor, and/or PC accessories. In some demonstrative embodiments the methods, devices and/or systems disclosed herein may be used in the field of professional A/V, for example, as part of any suitable camera, video camera, and/or A/V accessories. In some demonstrative embodiments the methods, devices and/or systems disclosed herein may be used in the medical field, for example, as part of any suitable endoscopy device and/or system, medical video monitor, and/or medical accessories. In some demonstrative embodiments the methods, devices and/or systems disclosed herein may be used in the field of security and/or surveillance, for example, as part of any suitable security camera, and/or surveillance equipment. In some demonstrative embodiments the methods, devices and/or systems disclosed herein may be used in the fields of military, defense, digital signage, commercial displays, retail accessories, and/or any other suitable field or application.

Although embodiments of the invention are not limited in this respect, one or more of the methods, devices and/or systems disclosed herein may be used to wirelessly transmit video signals, for example, High-Definition-Television (HDTV) signals, between at least one video source and at least one video destination. In other embodiments, the methods, devices and/or systems disclosed herein may be used to transmit, in addition to or instead of the video signals, any other suitable signals, for example, any suitable multimedia signals, e.g., audio signals, between any suitable multimedia source and/or destination.

Although some demonstrative embodiments are described herein with relation to wireless communication including video information, some embodiments may be implemented to perform wireless communication of any other suitable information, for example, multimedia information, e.g., audio information, in addition to or instead of the video information. Some embodiments may include, for example, a method, device and/or system of performing wireless communication of A/V information, e.g., including audio and/or video information. Accordingly, one or more of the devices, systems and/or methods described herein with relation to video information may be adapted to perform wireless communication of A/V information.

Some demonstrative embodiments may be implemented to communicate wireless-video signals over a wireless-video communication link, as well as Wireless-Local-Area-Network (WLAN) signals over a WLAN link. Such implementation may allow a user, for example, to play a movie, e.g., on a laptop computer, and to wirelessly transmit video signals corresponding to the movie to a video destination, e.g., a screen, while maintaining a WLAN connection, e.g., with the Internet and/or one or more other devices connected to a WLAN network. In one example, video information corresponding to the movie may be received over the WLAN network, e.g., from the Internet.

According to some embodiments of the present invention, there may include a video source transceiver for transmitting video information. The video source transceiver may include a video block component selector (VBCS) adapted to select from each of a set of video blocks one or more video block components. Components selection for a given video block in the set may be at least partially based on a visual quality metric (VQM) of the given video block. According to further embodiments of the present invention, the number of video block components selected may be directly related to the VQM.

According to some embodiments of the present invention, the video source transceiver may further comprise a superblock aggregator adapted to aggregate video information into a set of video blocks. According to further embodiments of the present invention, components selection for a given video block in the set may be at least partially based on a visual quality metric (VQM) of a neighboring (intra-set) video block.

According to some embodiments of the present invention, the video source transceiver may further comprise a channel bandwidth estimator adapted to estimate an available transmission bandwidth. According to further embodiments of the present invention, components selection for the set of video blocks may be at least partially based on the available transmission bandwidth. According to further embodiments of the present invention, components selection for a given video block in the set of video blocks may be at least partially based on the available transmission bandwidth.

According to some embodiments of the present invention, the VBCS may be further adapted to select more video block components from a given block in the set when the VQM of the given block is lower than a determined target VQM. According to further embodiments of the present invention, selecting more video block components from the given block may raise the VQM of the given block to a maximum achievable VQM. According to further embodiments of the present invention, the maximum achievable VQM may be constrained by the available transmission bandwidth. According to further embodiments of the present invention, the VBCS may be further adapted to select fewer video block components from a given block in the set when the VQM of the given block is higher than a determined target VQM.

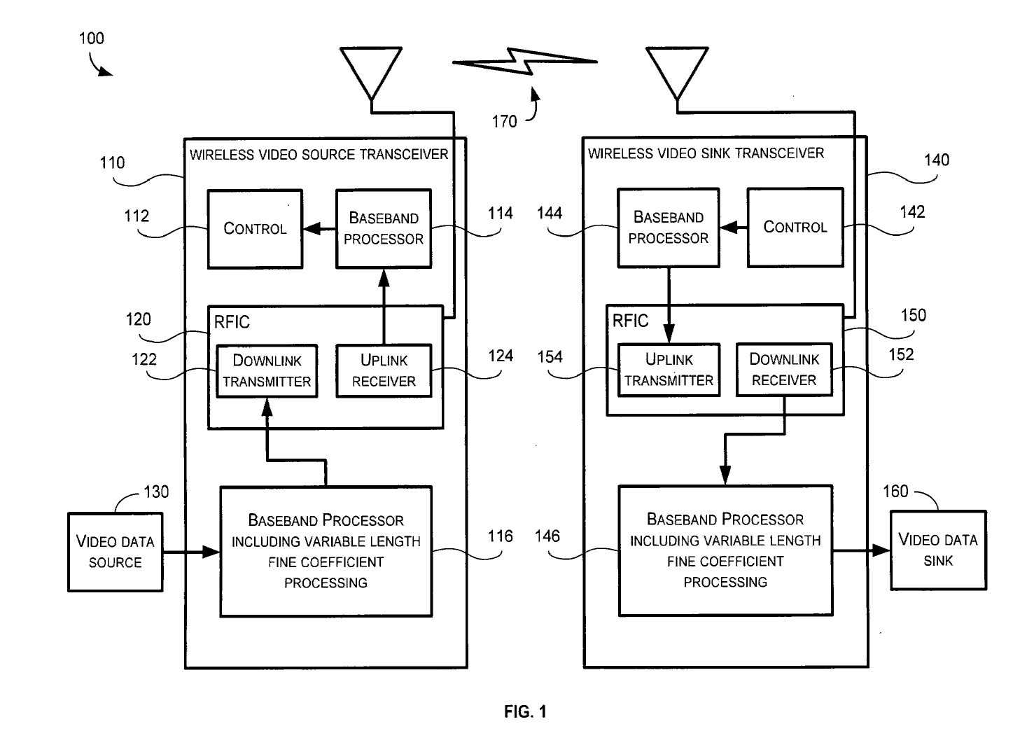

Now turning to FIG. 1, there is shown an exemplary video source transceiver and video sink transceiver arrangement (100), according to some embodiments of the present invention.

According to some embodiments of the present invention, a wireless video source transceiver (110) may include a radio-frequency integrated chip (RFIC) (120) to transmit and receive data signals along a functionally associated antenna. According to further embodiments of the present invention, the RFIC may include a downlink transmitter (122) for transmitting downlink data signals and an uplink receiver (124) for receiving uplink data signals.

According to some embodiments of the present invention, the wireless video source transceiver (110) may include a baseband processor (114) to process control signals received via the uplink receiver (124) and send the data to a functionally associated control circuit and/or processor (112). According to some embodiments of the present invention, the wireless video source transceiver (110) may include a baseband processor including variable length fine coefficient processing (116) to take incoming video data signals from a functionally associated video data source (130) and process the data for downlink transmission, via the downlink transmitter (122), to a functionally associated wireless video sink transceiver (140).

According to some embodiments of the present invention, a wireless video sink transceiver (140) may include a RFIC chip (150) to transmit and receive data signals along a functionally associated antenna. According to further embodiments of the present invention, the RFIC may include a downlink receiver (152) for receiving downlink data signals and an uplink transmitter (154) for transmitting uplink data signals.

According to some embodiments of the present invention, the wireless video sink transceiver (140) may include a baseband processor (144) to process control data received from a functionally associated control circuit and/or processor (142) and send the control data to the uplink transmitter (154). According to some embodiments of the present invention, the wireless video sink transceiver (140) may include a baseband processor including variable length fine coefficient processing (146) to take video data signals received, via the downlink receiver (152), from a functionally associated wireless video source transceiver (110) and process the data for a functionally associated video data sink (160).

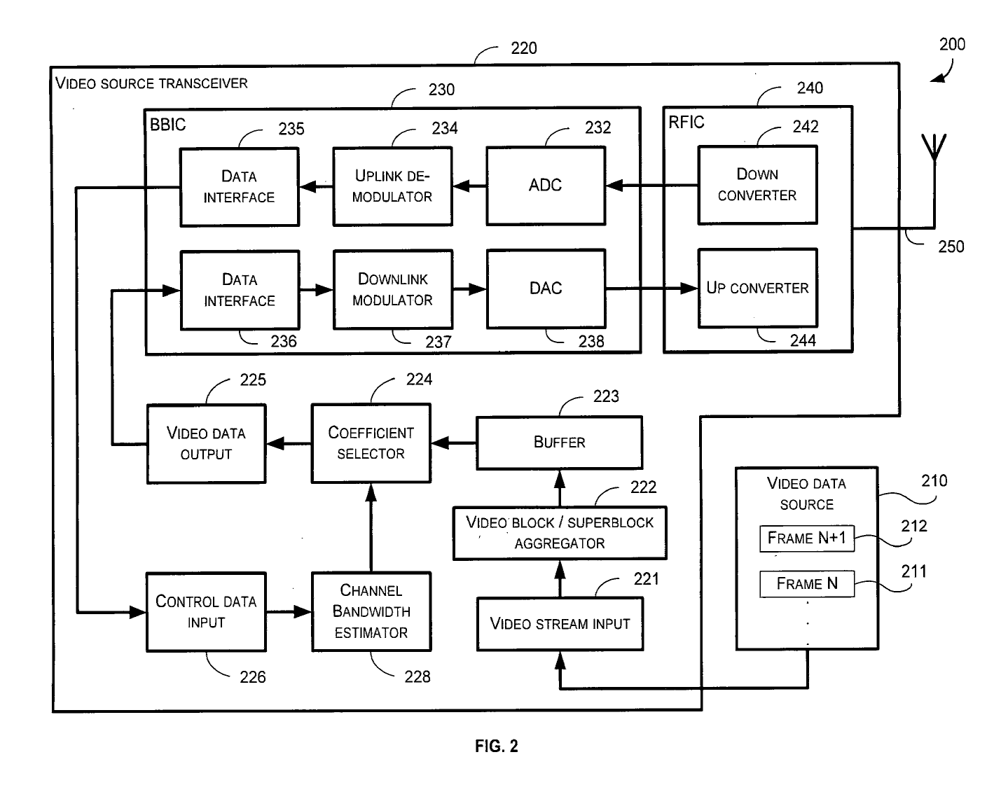

Now turning to FIG. 2, there is shown a functional block diagram (200) of an exemplary video source transceiver according to some embodiments of the present invention, where the video source transceiver includes a coefficient selector.

According to some embodiments of the present invention, there may include a video source transceiver (220) for transmitting and receiving video/audio data, in addition to processing, coding, decoding and/or formatting the video/audio data.

According to some embodiments of the present invention, the video source transceiver (220) may include a baseband integrated chip (BBIC) (230) and a radio-frequency integrated chip (RFIC) (240) to transmit and receive data signals along with functionally associated antenna(s) (250). According to further embodiments of the present invention, the RFIC (240) may include a down converter (242) for receiving and down converting uplink data signals and an up converter (244) for up converting and transmitting downlink data signals.

According to some embodiments of the present invention, the BBIC (230) may include a receive chain comprising an analog to digital converter (ADC) (232), an uplink demodulator (234) and a data interface (235). According to further embodiments of the present invention, the ADC (232) may receive analog signals from the down converter (242) and convert them into a corresponding digital form for the uplink demodulator (234). The uplink demodulator (234) may extract a data bearing signal from the received signal for the data interface (235) adapted to receive data bearing signals and to send them to a functionally associated control data input (226). The data bearing signals may include calculated channel bandwidth data.

According to some embodiments of the present invention, the BBIC (230) may include a transmission chain comprising a data interface (236), a downlink modulator (237) and a digital to analog converter (DAC) (238). According to further embodiments of the present invention, the data interface (236) may receive transmission symbols and send them to the downlink modulator (237) to generate a corresponding digital transmission signal. The DAC (238) may convert the transmission signal into a corresponding analog transmission signal for the up converter (244) to transmit the signal.

According to some embodiments of the present invention, the video source transceiver (220) may include a video stream input (221) to generate de-correlated data coefficients (e.g. DCT coefficients) based on video data frames (e.g. frame N, N+1, etc.) received from a functionally associated video data source (210). The de-correlated data coefficients may be sent to a functionally associated video block/superblock aggregator (222) to aggregate the coefficients into blocks of coefficients. According to further embodiments of the present invention, the blocks of coefficients may be further aggregated into superblocks. The aggregated superblocks may be buffered by a functionally associated or integral buffer (223).

According to some embodiments of the present invention, a functionally associated or integral coefficient selector (224) may receive a superblock from the buffer (223) and determine and select which data coefficients are suitable for transmission. Selection of one or more data coefficients to be transmitted may be based on a Visual Quality Metric (VQM) of the associated video block, such that encapsulation and transmission preference/priority may be given to maximize the VQM of the video block. According to further embodiments of the present invention, the determination/selection of data coefficients for a given video block may be based on the VQM of other video blocks within the same superblock. According to further embodiments of the present invention, a dynamic VQM threshold may vary based on available bandwidth on the transmission channel, such that the VQM threshold level may be proportional to the available bandwidth. The VQM threshold level may determine the total number of superblock coefficients that may be transmitted. Calculation of the available bandwidth on the transmission channel may be based on data received from an integral or functionally associated channel bandwidth estimator (228).

According to some embodiments of the present invention, selected coefficients may be sent to a video data output for conversion into transmission symbols using some predetermined mapping scheme (e.g. orthogonal frequency-division multiplexing—OFDM mapping).

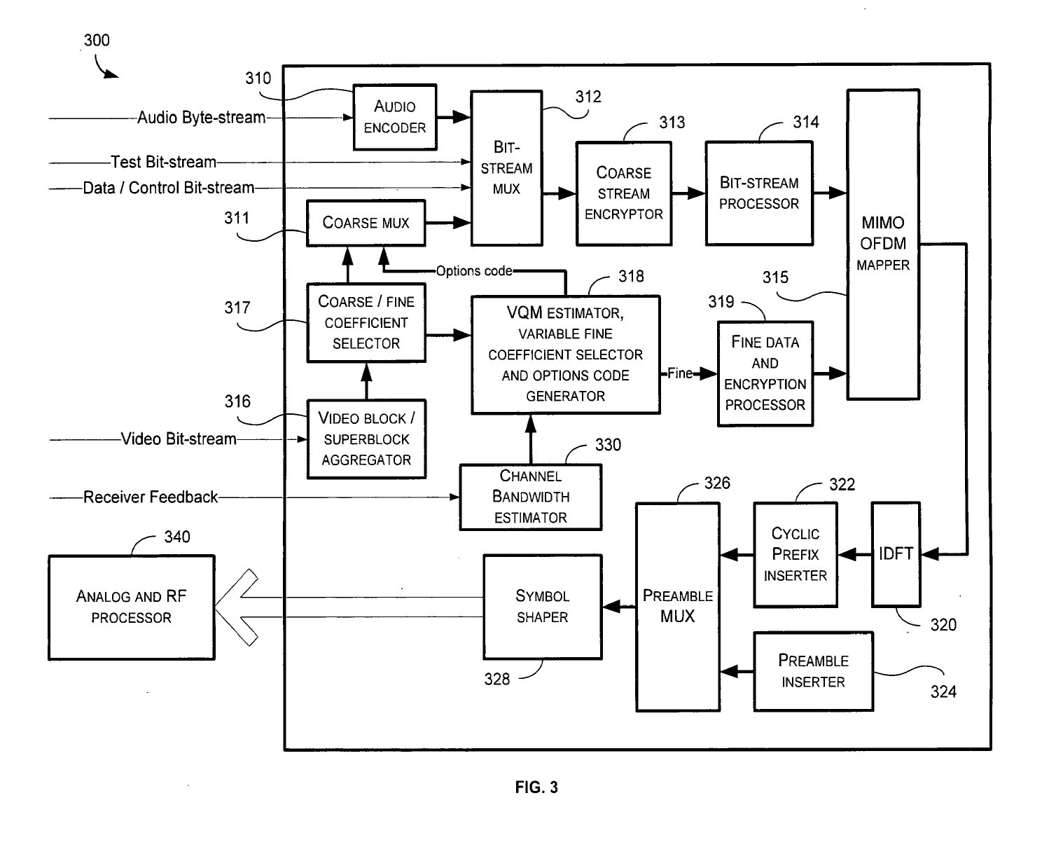

Now turning to FIG. 3, there is shown a functional block diagram of an exemplary coefficient selector and symbol generator (300), according to some embodiments of the present invention.

According to some embodiments of the present invention, the coefficient and symbol generator (300) may include a bit-stream mux (312) that may be input with a data/control bit-stream and a test bit-stream. According to further embodiments of the present invention, the mux (312) may be input with an audio byte-stream after the stream is processed by a functionally associated or integral audio encoder (310). According to further embodiments of the present invention, the mux (312) may be input with a coarse (i.e. analog-like) data set generated by a functionally associated or integral coarse mux (311). According to further embodiments of the present invention, the mux (312) may send received data to a functionally associated or integral coarse stream encryptor (313) for encryption (e.g. Advanced Encryption Standard—AES). The encrypted data may be sent to a functionally associated or integral bit-stream processor (314) for processing (e.g. convolutional encoding). According to further embodiments of the present invention, the processed coarse stream may be sent to a MIMO OFDM mapper (315) for some form of coarse, constellation, shape and/or analog mapping.

According to some embodiments of the present invention, the coefficient and symbol generator (300) may include a video block / superblock aggregator (316) that may be input with a video bit-stream received from some video data source. The video block/superblock aggregator (316) may aggregate the coefficients into blocks of coefficients. According to further embodiments of the present invention, the blocks of coefficients may be further aggregated into superblocks.

According to some embodiments of the present invention, a functionally associated or integral coarse/fine coefficient selector (317) may receive a superblock from the aggregator (316) and separate the data coefficients into coarse coefficients, for the coarse mux (311), and fine coefficients. While low spatial frequency coefficients (i.e. DC coefficients, and/or near DC coefficients) may be represented in a coarse (i.e. digital) manner, relatively higher frequency coefficients and the quantization errors of the DC and the near DC components may be mapped as fine-constellation points. Fine coefficients may provide the fine granularity (i.e. analog-like) values that at an extreme fineness provides for a continuous representation of these values.

According to some embodiments of the present invention, a VQM estimator, variable fine coefficient selector and options code generator (318) may determine and select which data coefficients are suitable for transmission. Selection of one or more data coefficients to be transmitted may be based on a Visual Quality Metric (VQM) of the associated video block, such that encapsulation and transmission preference/priority may be given to maximize the VQM of the video block. According to further embodiments of the present invention, the determination/selection of data coefficients for a given video block may be based on the VQM of other video blocks within the same superblock. According to further embodiments of the present invention, a dynamic VQM threshold may vary based on available bandwidth on the transmission channel, such that the VQM threshold level may be proportional to the available bandwidth. The VQM threshold level may determine the total number of superblock coefficients that may be transmitted. Calculation of the available bandwidth on the transmission channel may be based on data received from an integral or functionally associated channel bandwidth estimator (330).

According to some embodiments of the present invention, the VQM estimator, variable fine coefficient selector and options code generator (318) may generate an options code comprising a data code including the number of coefficients selected, data codes describing the location and length of a zero run, and the ordering of the selected coefficients. The options code may be sent to the functionally associated coarse mux (31 1) to be transmitted in a coarse (i.e. digital) manner.

According to some embodiments of the present invention, the VQM estimator, variable fine coefficient selector and options vector generator (318) may output a fine coefficient data set to a functionally associated or integral fine data and encryption processor (319) for processing (e.g. Hadamard) and encryption (e.g. AES). According to further embodiments of the present invention, the processed fine data set may be sent to the MIMO OFDM mapper (315) for some form of fine, constellation and/or shape symbol mapping.

According to some embodiments of the present invention, a symbol generated by the mapper (315) may be sent to a functionally associated or integral inverse discrete Fourier transformer (IDFT—320) for transforming the symbol into the time-domain. According to further embodiments of the present invention, a functionally associated or integral cyclic prefix inserter (322) may add a cyclic prefix to the symbol. According to further embodiments of the present invention, a functionally associated or integral preamble mux (326) may receive the symbol in addition to a preamble received from a functionally associated or integral preamble inserter (324). According to further embodiments of the present invention, a functionally associated or integral symbol shaper (328) may receive the data from the preamble mux (326) and process the data for transmission suitability (e.g. to avoid inter-symbol interference). The shaped data may be sent to a functionally associated analog and RF processor (330) for modulation, up-converting and transmitting.

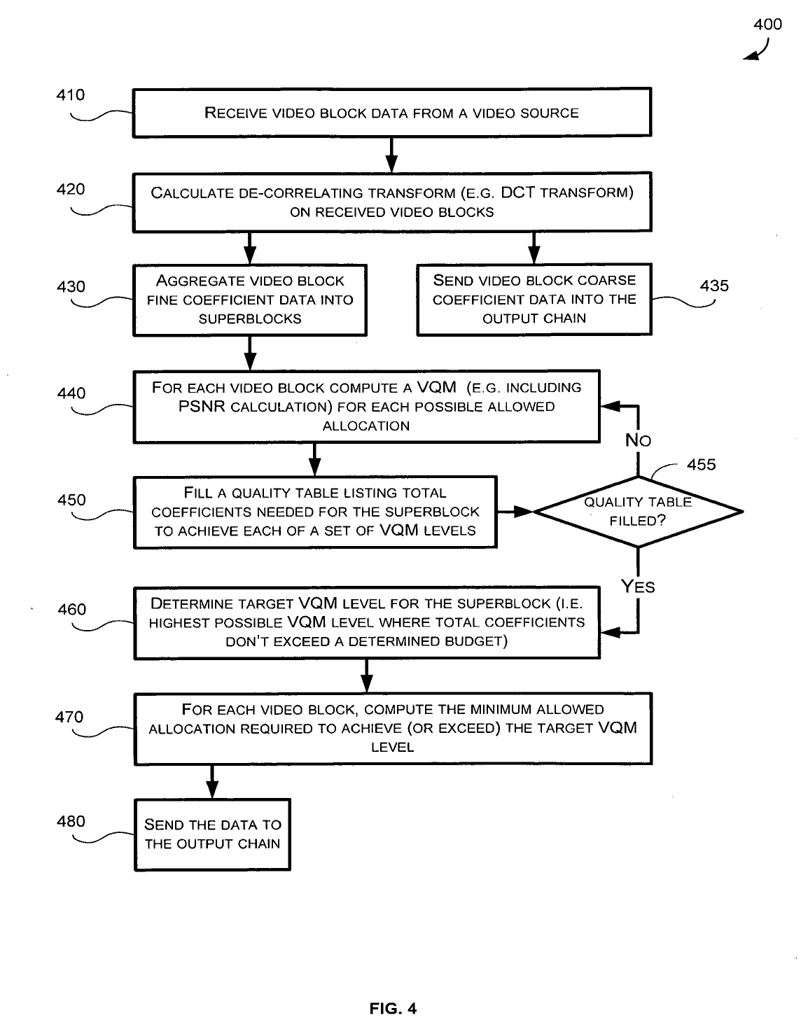

Now turning to FIG. 4, there shows a flowchart (400) including the steps performed by the video source transceiver, according to some embodiments of the present invention.

According to some embodiments of the present invention, the video source transceiver may receive (410) video block data from a video source and calculate (420) a de-correlating transform (e.g. discrete cosine transform—DCT) on the received video blocks. According to further embodiments of the present invention, video block fine coefficient data may be aggregated (430) into superblocks while video block coarse coefficient data may be sent (435) into the output chain of the transceiver.

According to some embodiments of the present invention, there may be determined a visual quality metric (VQM) donation threshold for the superblock. A video block from the superblock with a VQM lower than the VQM donation threshold may be guaranteed a minimum number of coefficients allocated for transmission (i.e. a minimum allowed allocation size). According to further embodiments of the present invention, the video source transceiver may compute (440) a VQM (e.g. including a peak signal-to-noise ratio—PSNR calculation) for each possible allowed allocation of fine coefficient data. For each video block, a quality table listing the total coefficients needed for the superblock to achieve each of a set of VQM levels (i.e. ranges) may be filled (450). This process continues (455) until the VQM levels are computed for each block and the associated values entered into the quality table. According to further embodiments of the present invention, a target VQM level for the superblock may be determined (460) as the highest possible VQM level where total coefficients don't exceed a determined budget. The determined budget may be based on a transmission bandwidth available to the transceiver.

According to some embodiments of the present invention, for each video block the video source transceiver may compute (470) the minimum allowed allocation required to achieve (or exceed) the target VQM level. According to further embodiments of the present invention, the video source transceiver may send (480) the data coefficients to the output chain.

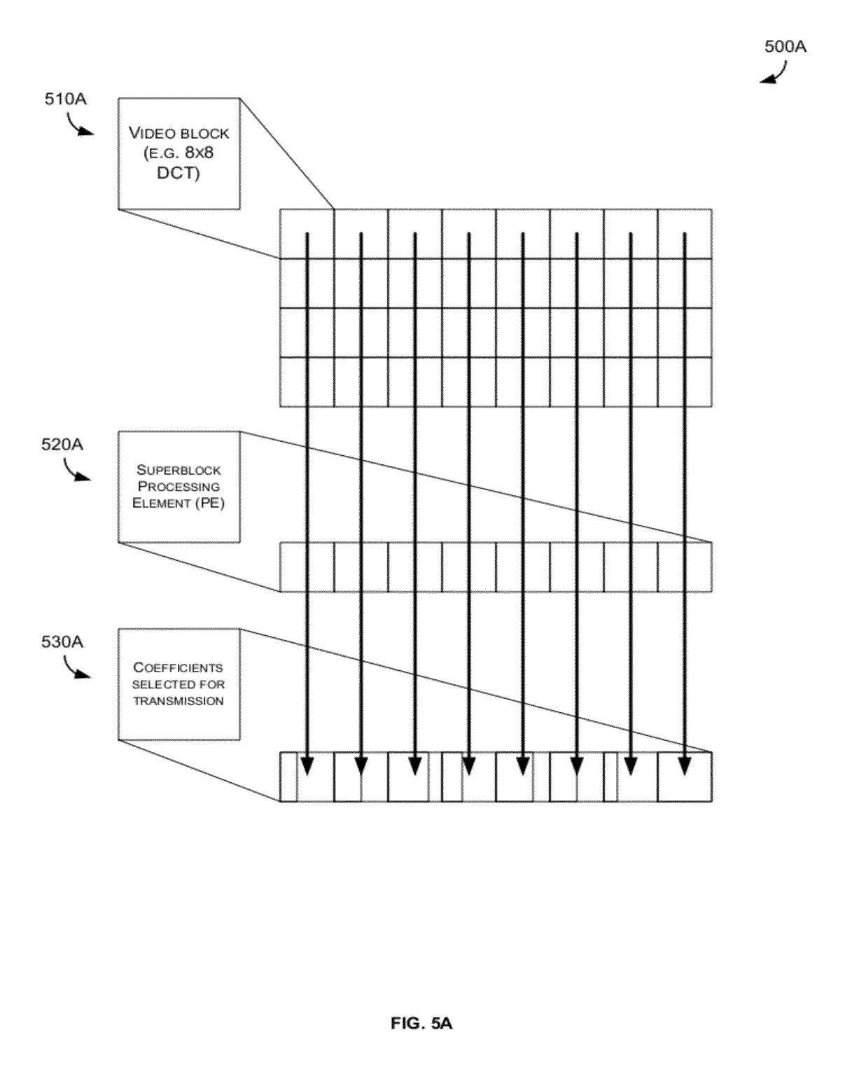

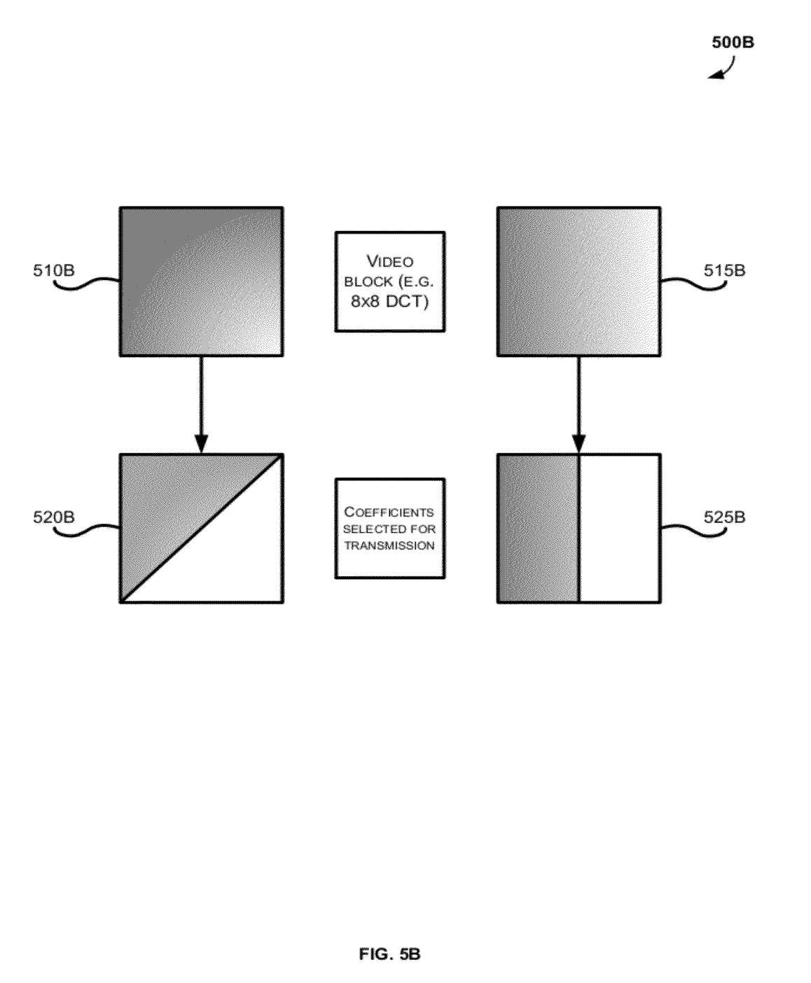

Now turning to FIG. 5A, there is shown a schematic diagram showing computational parallelization of superblock coefficients (500A) according to some embodiments of the present invention.

According to some embodiments of the present invention, fine coefficient blocks (e.g. 8×8 DCT blocks) may be aggregated (510A) into superblocks (i.e. a row of video blocks). A superblock processing element (520A) may simultaneously calculate the required coefficients for each block. For blocks with a horizontal priority coefficient ordering (i.e. DCT coefficient ordering optimal for horizontal lines), the coefficients selected for transmission (530A) may be the coefficients from the left edge of the block up to some level within the block (i.e. from one or more columns of coefficients).

Now turning to FIG. 5B, there is shown a schematic diagram showing selectable video block coefficients ordering (500B) according to some embodiments of the present invention.

According to some embodiments of the present invention, fine coefficient blocks (e.g. 8×8 DCT blocks) may be ordered in a zigzag ordering (510B) or a horizontal priority ordering (i.e. DCT coefficient ordering optimal for horizontal lines—515B). For a zigzag ordering, the highest energy coefficients may be concentrated towards the upper left corner of the coefficient block. For a horizontal priority ordering, the highest energy coefficients may be concentrated towards the left side of the coefficient block. According to further embodiments of the present invention, for a zigzag ordering, the coefficients selected for transmission (520B) may consist of the coefficients along diagonal lines starting from the upper left corner of the block. According to further embodiments of the present invention, for a horizontal priority ordering, the coefficients selected for transmission (525B) may consist of the coefficients along columns starting from the left side of the block.

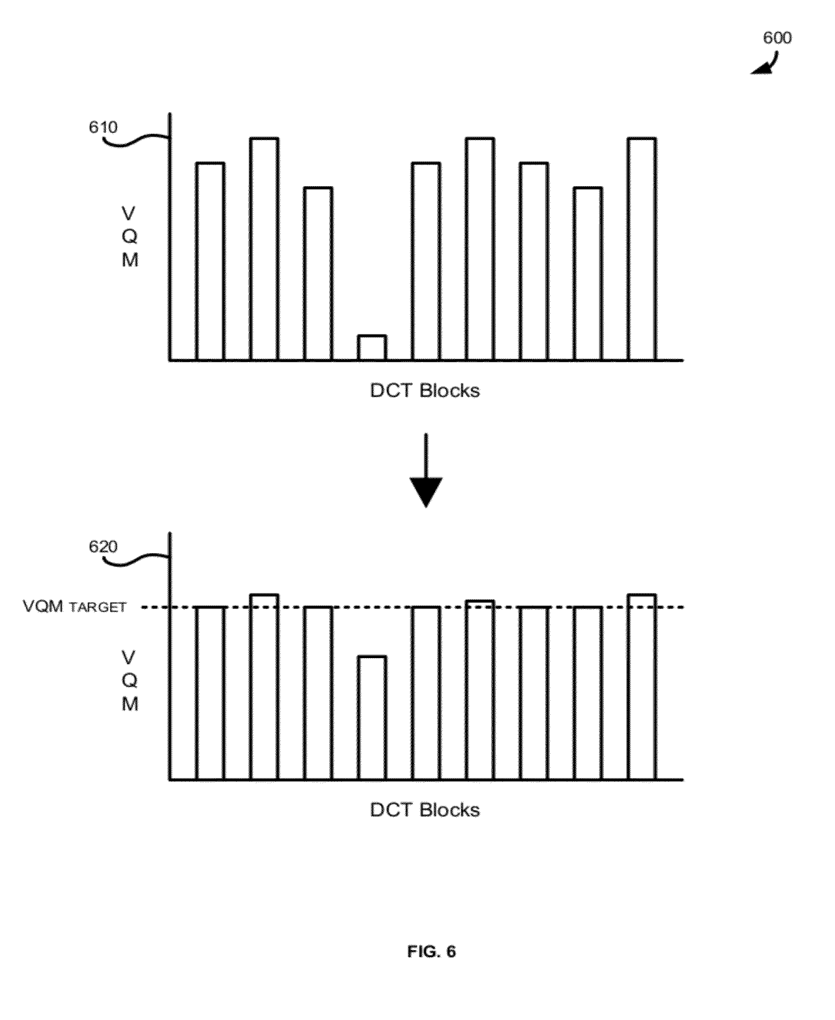

Now turning to FIG. 6, there is shown a schematic diagram showing superblock coefficients allocation (600) based on block-specific energy levels according to some embodiments of the present invention.

According to some embodiments of the present invention, DCT blocks comprising a superblock may be determined (610) to have varying VQM levels (i.e. PSNR levels). According to further embodiments of the present invention, the superblock coefficient allocation (620) may include an algorithm whereby high VQM DCT blocks donate coefficient allocation to low VQM DCT blocks. The algorithm may include a max/min algorithm that maximizes the minimal VQM of a video block from a superblock, limited to allowed allocations.

According to some embodiments of the present invention, there may be determined a target VQM for the superblock. Coefficient allocation may be donated from high VQM DCT blocks when the VQM of the block is above VQM target. According to further embodiments of the present invention, a DCT block VQM may be higher than VQM target when a minimal allowed coefficient allocation exceeds VQM target.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A video source transceiver for transmitting video information, said transceiver comprising:
a video block component selector (VBCS) adapted to select from each of a set of video blocks one or more video block components, wherein components selection for a given video block in the set is at least partially based on a visual quality metric (VQM) of the given video block.

2. The video source transceiver according to claim 1, wherein the number of video block components selected is directly related to the VQM.

3. The video source transceiver according to claim 1, further comprising a superblock aggregator adapted to aggregate video information into a set of video blocks.

4. The video source transceiver according to claim 3, wherein components selection for a given video block in the set is at least partially based on a visual quality metric (VQM) of a neighboring (intra-set) video block.

5. The video source transceiver according to claim 1, further comprising a channel bandwidth estimator adapted to estimate an available transmission bandwidth.

6. The video source transceiver according to claim 5, wherein components selection for the set of video blocks is at least partially based on the available transmission bandwidth.

7. The video source transceiver according to claim 6, wherein components selection for a given video block in the set of video blocks is at least partially based on the available transmission bandwidth.

8. The video source transceiver according to claim 7, wherein said VBCS is further adapted to select more video block components from a given block in the set when the VQM of the given block is lower than a determined target VQM.

9. The video source transceiver according to claim 8, wherein selecting more video block components from the given block raises the VQM of the given block to a maximum achievable VQM.

10. The video source transceiver according to claim 9, wherein the maximum achievable VQM is constrained by the available transmission bandwidth.

11. The video source transceiver according to claim 7, wherein said VBCS is further adapted to select fewer video block components from a given block in the set when the VQM of the given block is higher than a determined target VQM.
